(19) United States
(12) Patent Application Publication
(10) Pub. No.: US 2008/0225864 A1
(43) Pub. Date: Sep. 18, 2008

(54) COMMUNICATION NETWORK ROUTING APPARATUS AND TECHNIQUES USING LOGICAL COMMUNICATION LINKS

(76) Inventors: Mustapha Aissaoui, Kanata (CA); Andrew Dolganow, Kanata (CA); Matthew Bocci, Stoke Newington (GB); Alexey Zinin, Cupertino, CA (US); Dimitri Papadimitriou, Brussels (BE)

Correspondence Address: ECKERT SEAMANS CHERIN & MELLOTT, LLC., 600 GRANT STREET, 44TH FLOOR, PITTSBURGH, PA, 15219, US

(21) Appl. No.: 11/687,214

(22) Filed: Mar. 16, 2007

(51) Int. Cl. H04L 12/46

(52) U.S. Cl. 370/401; 370/255

(57) ABSTRACT

Communication network routing apparatus and techniques using logical communication links are disclosed. A routing apparatus identifies a logical communication link that it is capable of being used to establish a virtual connection with another routing apparatus within a virtual connection operational domain, which includes multiple sub-domains, of an underlying communication system. A destination that is associated with the routing apparatus and is reachable through the virtual connection is also identified. Information that is indicative of the identified logical communication link and of the identified destination is provided for distribution from a sub-domain of the routing apparatus in the virtual connection operational domain to another sub-domain within the virtual connection operational domain. This distribution of information enables a routing apparatus in one sub-domain to dynamically route a virtual connection toward a destination in a different sub-domain. Data structures for distributing the information are also disclosed.

### FIELD OF THE INVENTION

This invention relates generally to communications and, in particular, to virtual connections that are established over underlying communication network links by using logical communication links.

### BACKGROUND

Multi-Segment PseudoWires (MS-PWs) have been defined to enable emulated Layer 1 and Layer 2 services to be delivered from an IP-based Packet Switched Network (PSN) over a sparse mesh of PSN tunnels and PW control protocol adjacencies. MS-PWs can be used to scale PW-based networks over a single Autonomous System (AS), or between multiple ASs.

According to one basic approach to MS-PWs, switching points along an MS-PW are statically placed. Techniques that allow the automatic placement of MS-PW switching points have also been proposed. MultiProtocol Border Gateway Protocol (MP-BGP) is used to distribute Forwarding Equivalence Class (FEC) routing information required for dynamic placement of PWs in one proposed technique. Normally, however, implementations of MP-BGP, as well as other protocols capable of carrying external routing information, are primarily focused on scenarios where domains between which a PW or a PW segment of an MS-PW is to be established are in separate ASs, and border routers and protocols are used to switch PWs between adjacent ASs.

A second important case can be the situation in which MS-PWs are deployed in service provider access and metro networks. PWs in these networks typically span only a single Interior Gateway Protocol (IGP) domain or AS. Network nodes in metro and access networks tend to contain only minimal routing implementations in order to limit operational complexity. Inter-AS protocols such as MP-BGP are not typically deployed, and full functionality of such protocols is in most cases not required. However, it may be desirable to be able to automatically route MS-PWs between domains in these topologies.

Thus, there remains a need for improved techniques relating to PWs and other types of logical communication links.

### SUMMARY OF THE INVENTION

Some embodiments of the invention provide a mechanism that supports dynamic routing of MS-PWs in a single Open Shortest Path First (OSPF) AS.

According to one aspect of the invention, a communication traffic routing apparatus includes a logical topology determination module and a distribution module. The logical topology determination module is operable to identify a logical communication link that is capable of being used to establish a virtual connection between the routing apparatus and another routing apparatus within a virtual connection operational domain of an underlying communication system, the virtual connection operational domain comprising multiple sub-domains, and to identify a destination that is associated with the routing apparatus and is reachable through the virtual connection. The distribution module is operatively coupled to the logical topology determination module and is operable to provide information, which is indicative of the identified logical communication link and of the identified destination, for distribution from a sub-domain of the routing apparatus in the virtual connection operational domain to another sub-domain within the virtual connection operational domain.

In some embodiments, the logical topology determination module is operable to identify a logical communication link by determining another routing apparatus with which the routing apparatus has a signalling adjacency. The information indicative of the identified logical communication link may then include information identifying the other routing apparatus.

The logical topology determination module may be operable to identify an attachment circuit of the routing apparatus as a destination that is associated with the routing apparatus and is reachable through the virtual connection.

The virtual connection is a PW in some embodiments.

The information may be provided in a message of an IGP such as OSPF protocol or Intermediate System to Intermediate System (IS-IS) protocol.

Such a routing apparatus may also include a routing module that is operatively coupled to the logical topology determination module and is operable to cause the virtual connection to be established using the identified logical communication link. The routing module may be operable to cause the virtual connection to be established as a segment of a multi-segment virtual connection.

In some embodiments, the logical topology determination module is further operable to receive from another routing apparatus in the virtual connection operational domain information indicative of a logical communication link that is capable of being used to establish a virtual connection with the other routing apparatus and of a destination that is associated with the other routing apparatus and is reachable through the virtual connection with the other routing apparatus.

The routing apparatus may also include a routing table generator operatively coupled to the logical topology determination module and operable to generate a routing table based on the identified logical communication link, the identified destination, and the information received from the other routing apparatus.

The logical communication link may be a Targeted Label Distribution Protocol (T-LDP) adjacency, in which case the information indicative of the logical communication link comprises information indicative of the T-LDP adjacency and its properties. The information indicative of the identified destination may in some embodiments comprise an Attachment Circuit (AC) identifier and properties of the AC.

A method is also provided, and involves identifying, at a routing apparatus, a logical communication link that is capable of being used to establish a virtual connection between the routing apparatus and other routing apparatus within a virtual connection operational domain of an underlying communication system, the virtual connection operational domain comprising multiple sub-domains, identifying a destination that is associated with the routing apparatus and is reachable through the virtual connection, and providing information, which is indicative of the identified logical communication link and of the identified destination, for distribution from a sub-domain of the routing apparatus in the virtual connection operational domain to another sub-domain within the virtual connection operational domain.

The operation of identifying a logical communication link may involve determining another routing apparatus with which the routing apparatus has a signalling adjacency.

The information indicative of the identified logical communication link may include information identifying the other routing apparatus.

As noted above, the virtual connection may be a PW.

Providing information may involve providing the information in message of an IGP such as OSPF protocol or IS-IS protocol.

The method may also involve the routing apparatus causing the virtual connection to be established using the identified logical communication link. The virtual connection may be established as a segment of a multi-segment virtual connection.

In some embodiments, the method also involves receiving from another routing apparatus in the virtual connection operational domain information indicative of a logical communication link that is capable of being used to establish a virtual connection with the other routing apparatus and of a destination that is associated with the other routing apparatus and is reachable through the virtual connection with the other routing apparatus.

Such a method may be embodied, for example, in instructions stored on a computer-readable medium.

A communication traffic routing apparatus according to a further aspect of the invention includes a routing module operable to cause virtual connections with other routing apparatus within a virtual connection operational domain of an underlying communication system to be established using logical communication links, the virtual connection operational domain comprising multiple sub-domains, and a route determination module operatively coupled to the routing module and operable to determine whether any of the logical communication links can be used to establish a virtual connection toward a destination in a different sub-domain of the virtual connection operational domain than the routing apparatus, and to select a logical communication link to be used to establish a virtual connection toward the destination where it is determined by the route determination module that a logical communication link can be used to establish a virtual connection toward the destination.

The virtual connection toward the destination may be a segment of a multi-segment virtual connection.

A method in accordance with yet another aspect of the invention involves identifying at a routing apparatus logical communication links that are capable of being used to establish virtual connections with other routing apparatus in a virtual connection operational domain of an underlying communication system, the virtual connection operational domain comprising multiple sub-domains, determining whether any of the identified logical communication links can be used to establish a virtual connection toward a destination in a different sub-domain of the virtual connection operational domain than the routing apparatus, and selecting an identified logical communication link to be used to establish a virtual connection toward the destination where it is determined that a logical communication link can be used to establish a virtual connection toward the destination.

A computer-readable medium storing a data structure is also provided. The data structure includes logical communication link information indicative of a logical communication link that is capable of being used to establish a virtual connection between the routing apparatus and other routing apparatus within a virtual connection operational domain of an underlying communication system, the virtual connection operational domain comprising multiple sub-domains, destination information indicative of a destination that is associated with the routing apparatus and is reachable through the virtual connection, and distribution information for causing the logical communication link information and the destination information to be distributed from a sub-domain of the routing apparatus in the virtual connection operational domain to another sub-domain within the virtual connection operational domain. The logical communication link information and the destination information enable dynamic routing of the virtual connection toward the destination by routing apparatus in the other sub-domain.

The logical communication link information may include respective Type/Length/Value (TLV) triplets comprising, for each of a plurality of logical communication links that are capable of being used to establish virtual connections between the routing apparatus and other routing apparatus within the virtual connection operational domain, an address of the routing apparatus and an address of a remote routing apparatus with which a virtual connection can be established using the logical communication link.

In some embodiments, the destination information includes respective TLV triplets comprising an address of each destination that is associated with the routing apparatus and is reachable through the virtual connection.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of a communication system.

FIG. 2 is a block diagram of a collection of network elements in multiple operational/administrative sub-domains of a communication system.

FIG. 3 is a block diagram of a logical communication link topology overlay on the network elements of FIG. 2.

FIG. 4 is a block diagram of a routing apparatus.

FIG. 5 is a flow diagram of a method of managing virtual connections using logical communication links.

FIG. 6 is a block diagram of an example advertisement for distributing information associated with logical communication links and destinations.

FIG. 7 is a block diagram of another example advertisement for distributing information associated with logical communication links and destinations.

FIG. 8 is a block diagram of a Type/Length/Value (TLV) triplet.

### DETAILED DESCRIPTION OF PREFERRED EMBODIMENTS

The description below refers to the following documents or the technologies disclosed therein:

Moy, “OSPF Version 2”, Request for Comments (RFC)-2328, The Internet Society, April 1998;

Coltun, “The OSPF Opaque LSA Option”, RFC-2370, The Internet Society, July 1998;

Coltun, et al., “OSPF for IPv6”, RFC-2740, The Internet Society, December 1999;

Pillay-Ensault, “OSPF Refresh and Flooding Reduction in Stable Topologies”, RFC-4136, The Internet Society, July 2005;

Martini, et al., “Pseudowire Setup and Maintenance Using the Label Distribution Protocol (LDP)”, RFC-4447, The Internet Society, April 2006;

Ishiguro, et al., “Traffic Engineering Extensions to OSFP version 3”, Internet-Draft, The IETF Trust, Jan. 3, 2007;

“Intermediate System to Intermediate System Intra-Domain Routeing Exchange Protocol for use in Conjunction with the Protocol for Providing the Connectionless-mode Network Service (ISO 8473)”, ISO DP 10589, February 1990;

Kompella, et al., “Intermediate System to Intermediate System (IS-IS) Extensions in Support of Generalized Multi-Protocol Label Switching (GMPLS)”, RFC-4205, The Internet Society, October 2005.

The entire contents of each of the above-referenced documents is incorporated herein by reference.

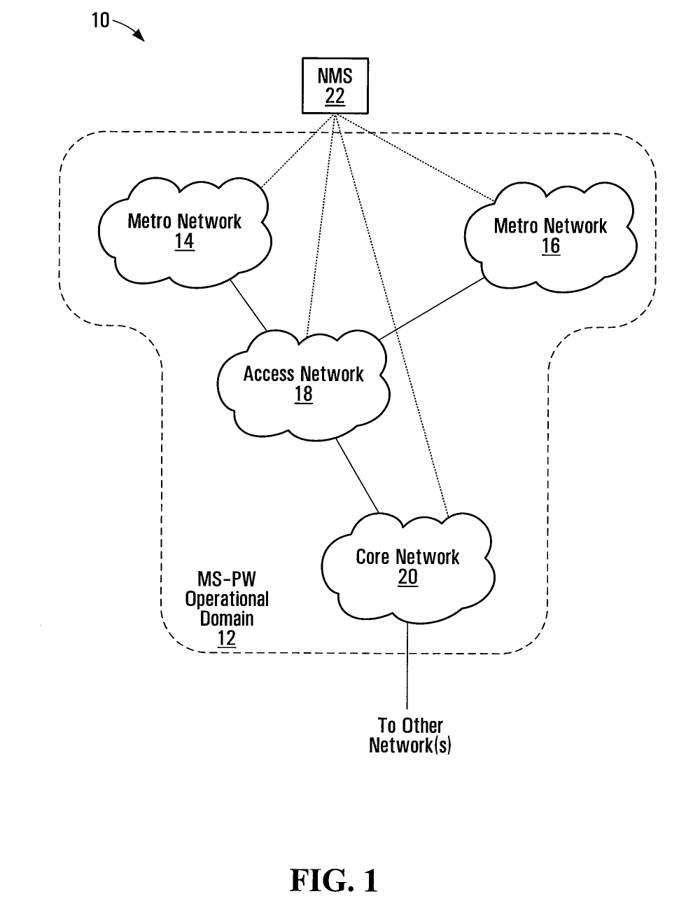

FIG. 1 is a block diagram of a communication system in which embodiments of the invention may be implemented. The communication system 10 includes several operational/administrative sub-domains, in the form of metro networks 14, 16, an access network 18, and a core network 20, within a virtual connection operational domain, of which an MS-PW operational domain 12 is shown as an illustrative example. A Network Management System (NMS) 22 is one example of a type of system that can be used to perform control, management, and/or other administrative functions for communication equipment in the MS-PW operational domain 12.

It should therefore be appreciated that the system of FIG. 1, as well as the contents of the other drawings, are intended solely for illustrative purposes, and that the present invention is in no way limited to the particular example embodiments explicitly shown in the drawings and described herein.

For example, each of the sub-domains 14, 16, 18 of the MS-PW operational domain 12 could itself be a domain with separate administrative or/and operational boundaries, that are brought together or managed separately at the single AS level. An MS-PW operational domain is thus intended to convey the notion of a collection of communication equipment that is capable of dynamically establishing MS-PWs between different sub-domains, without relying on an external protocol such as BGP. Each sub-domain, which may be an operational and/or administrative domain within an MS-PW, is also capable of establishing internal single- or multi-segment PWs, such that MS-PWs can be established between endpoints in different sub-domains of an MS-PW operational domain.

More generally, a virtual connection operational domain, of which an MS-PW operational domain is one example, is intended to represent a collection of communication equipment, illustratively routers, that is capable of establishing virtual connections between sub-domains using information that is distributed to those sub-domains through an interior protocol. An Interior Gateway Protocol (IGP) such as OSPF or Intermediate System to Intermediate System (IS-IS) could be used for this purpose.

It should also be appreciated that different combinations of metro, access, and core networks than shown in FIG. 1 are possible. Other types of operational and/or administrative sub-domains than these networks, such as different IGP areas in one AS or different administratively established sub-domains for instance, are also contemplated.

References herein to operational domains and to sub-domains should be interpreted accordingly.

Those skilled in the art will be familiar with communication systems in which a single MS-PW operational domain includes multiple operational and/or administrative sub-domains, as shown in FIG. 1. Carrier networks, for instance, are often arranged in this manner. The metro networks 14, 16 provide for communications with relatively dense collections of customers. The access network 18 allows these and possibly other customers to communicate with each other and, through the core network 20, with remote locations outside the MS-PW operational domain 12. Switches and routers are illustrative of the types of communication equipment that may be used to implement the networks 14, 16, 18, 20.

Communication links within and between the networks 14, 16, 18, 20 may be established through any of various techniques. Typically, communication links within each operational/administrative sub-domain can be routed dynamically, whereas links between sub-domains are statically configured by an operator using the NMS 22 or some other terminal. In general, communication links between operational/administrative sub-domains within the same MS-PW operational domain such as 12 involve some sort of interaction with an NMS 22 or other system(s) that would have either a high-level view of the entire MS-PW operational domain or a view of required interconnections between the operational/administrative sub-domains.

The present invention is in no way limited to any particular types of communication systems or arrangements, and accordingly the communication system 10 is described briefly herein. Illustrative examples of communication systems and their operation are described in further detail below to the extent necessary to illustrate embodiments of the invention.

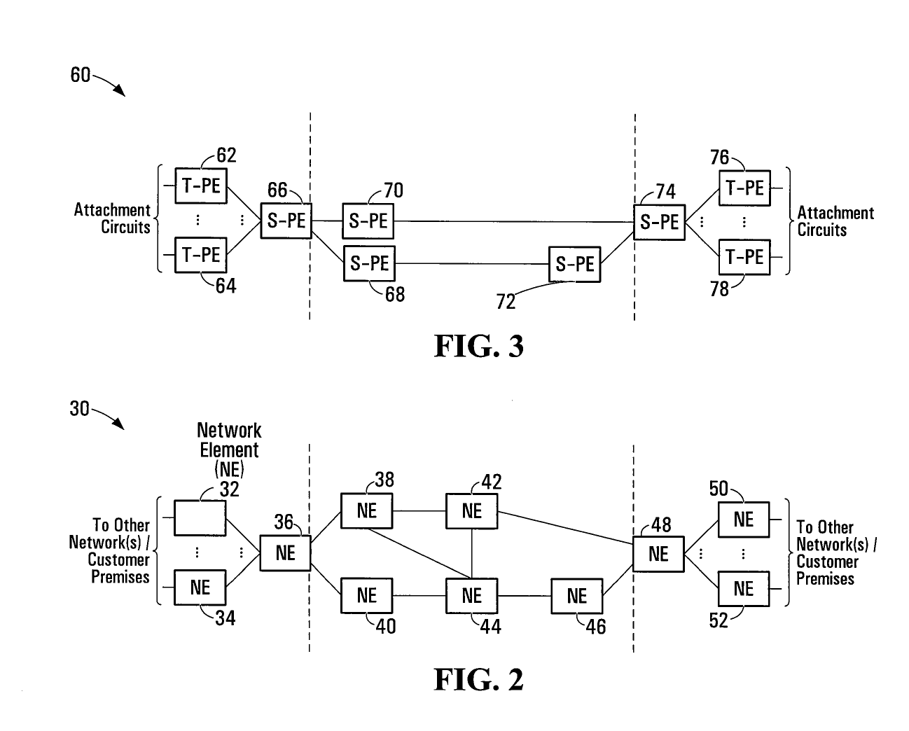

FIG. 2 is a block diagram of a collection of network elements (NEs) 32, 34, 36, 38, 40, 42, 44, 46, 48, 50, 52 in multiple operational/administrative sub-domains of a communication system 30. For the purposes of illustrating embodiments of the invention, the system 30 is intended to represent a single MS-PW operational domain that includes multiple operational/administrative sub-domains. The operational/administrative sub-domains are delineated in FIG. 2 by dashed lines. Other components may be provided in a communication system, such as components to support administrative, control, and management functions, for example, but have not been explicitly shown in FIG. 2 so as to avoid overly complicating the drawing.

The operational/administrative sub-domain that includes the NEs 32, 34, 36 and the operational/administrative sub-domain that includes the NEs 48, 50, 52 might be metro networks, and the other sub-domain might be an access network, for example. In this case, one or more of the NEs 38, 40, 42, 44, 46 may also be connected to NEs in a core network and/or other network (not shown). As noted above, however, other types of operational/administrative sub-domains are also possible. Those sub-domains may be defined in terms of different IGP areas or at a higher protocol level, as PW domains, for example. The dashed lines shown in FIG. 2 should therefore not be interpreted as indicating that operational/administrative sub-domains must be defined by some sort of physical layer arrangement.

Interconnections between the NEs shown in FIG. 2 may include wired, wireless, or both wired and wireless communication links. The present invention is not restricted to any particular types of communication links within or between operational/administrative sub-domains, or to any particular protocols or transfer mechanisms. Embodiments of the invention might be particularly useful to establish PWs to support higher-level services over connectionless networks such as packet switched networks (PSNs), although the techniques disclosed herein may be used in conjunction with any of various underlying communication links, such as Internet Protocol (IP) and MultiProtocol Label Switching (MPLS) tunnels, for example.

The NEs 32, 34, 36, 38, 40, 42, 44, 46, 48, 50, 52 shown in FIG. 2 are routers in one embodiment. Routers, especially in implementations such as access and metro networks where large numbers of NEs are to be deployed at as low a cost as possible, may employ only limited routing functionality to reduce cost and complexity. Communication links between routers may be established statically or dynamically, independently by the routers or under control of a management/control system such as an NMS.

PWs and other types of virtual connections may also be established, between NEs such as routers, over underlying communication links. The underlying communication links include at least physical layer links, and may also themselves include other logical communication links. In one embodiment, the techniques disclosed herein are applied to PWs over underlying MPLS tunnels in an IP network. Although a virtual connection such as a PW behaves substantially as a fixed path from the point of view of its endpoints, the actual transport path in an underlying communication system over which virtual connection traffic is transferred is not necessarily fixed. A PW between endpoint routers, for example, might be established over a connectionless network, in which case the actual transport path would not be fixed. References herein to virtual connections should be interpreted accordingly.

In order to more clearly illustrate logical communication links and thus embodiments of the invention, FIG. 3 shows a logical communication link topology overlay on the network elements of FIG. 2. The logical topology 60 includes Provider Edge routers (PEs) 62, 64, 66, 68, 70, 72, 74, 76, 78. Each logical communication link represents, in one embodiment, a Targeted Label Distribution Protocol (T-LDP) session established between PEs for PW signalling within each administrative/operational sub-domain and between the sub-domains. The routers 62, 64, 76, 78 are Terminating PE routers (T-PEs) having associated attachments circuits for establishing MS-PWs for connections to other equipment that is not part of the logical topology, such as customer premises equipment, an NE that is not capable of participating in the logical topology, equipment in another communication network, etc. The routers 66, 68, 70, 72, 74 are Switching PE routers (S-PEs), which are capable of switching communication traffic between PW segments of an MS-PW. Although not explicitly shown in FIG. 3, multiple routers may exist on a logical communication link between two T-PE's, two S-PEs, or a T-PE and S-PE.

PE routers are shown in FIG. 3 as a representative example of the type of routing apparatus that might be used to implement the techniques disclosed herein. This is not in any way intended to limit the scope of the present invention. For example, although PE routers are associated with particular communication protocols, embodiments of the invention are not limited to such protocols. Those skilled in the art will be familiar with PE routers, their operation, and the associated protocols, and accordingly embodiments of the invention can be effectively illustrated in the context of PE routers. Based on the illustrative example of PE routers, those skilled in the art will be enabled to implement the techniques disclosed herein in conjunction with other types of routing apparatus and protocols.

It will be apparent from a comparison of FIGS. 2 and 3 that not all routers in an MS-PW operational domain need necessarily be capable of participating in communications at the logical overlay level. As noted above, multiple routers may exist on logical communication links between two T-PE's, two S-PEs, or a T-PE and S-PE. An NE that is not itself logical link-capable may thus be involved in transporting logical link control signalling and traffic between logical link-capable NEs, but may only participate in a limited scope of logical link functions or not participate at all in logical link functions such as actual processing of logical link signalling or traffic. Considering the logical link between the S-PEs 68, 72, for example, the NEs 40, 44, and 46 may all be involved in transporting logical link signalling and traffic. The NE 44 is not an S-PE, but might be a so-called intermediate P router in this example.

Thus, more generally, a logical topology might not exactly reflect the topology of a communication system. Suppose that the NEs 42, 44 are also operatively coupled to other NEs (not shown). In this case, those other NEs will not be reachable through the logical topology 60, since the NEs 42, 44 are not part of the logical topology. Those other NEs may, however, participate in forwarding of MS-PW traffic or forwarding of signalling/control traffic exchanged over logical communication links.

The logical communication links shown in FIG. 3 can be used to establish virtual connections for carrying communication traffic between PEs. In an MPLS network, for example, a pair of PEs will establish a logical communication link in the form of a T-LDP session to exchange PW labels and thereby establish a PW over one or more underlying MPLS tunnels between the PEs.

Although illustrative embodiments of the invention described in detail herein relate primarily to establishment of virtual connections in the form of point-to-point (P2P), bi-directional MS-PWs, the present invention is not limited to P2P MS-PWs. It will be apparent to those skilled in art that other types of MS-PWs like point-to-multipoint, multipoint-to-point, multipoint-to-multipoint, and both uni- and bi-directional PWs may be established using the techniques disclosed herein. Accordingly, references to virtual connections, and to PWs in particular, should be interpreted to encompass at least these types of PWs.

References to destinations and virtual connections toward destinations should also be interpreted in a non-limiting manner. A destination is intended to convey the notion of a far-end component with which communication traffic is to be exchanged over a virtual connection, and is not intended to connote a direction of traffic flow on a virtual connection. It should be noted that a destination may or may not be the endpoint of a virtual connection. For example, in the case of an AC of a router as a destination, the router itself may be the endpoint of a PW, whereas the AC is the destination with which communication traffic is to be exchanged using the PW.

A virtual connection toward a destination is intended to generally describe a virtual connection that forms at least part of a virtual connection between a routing apparatus and a virtual connection endpoint that is associated with the destination. In the example of an MS-PW, any segment of the MS-PW may be considered a virtual connection toward the destination. Again, no connotation of direction of traffic flow is intended by references to a virtual connection toward a destination.

Although it is possible to use MP-BGP and other border or exterior protocols to distribute information for routing such connections, these protocols are not intended for use between sub-domains in a single virtual connection operational domain. Implementation of such protocols at metro or access network routers, for example, would add complexity and thus cost to the routers. A separate Path Computation Element (PCE) is another option for PW routing, and similar elements could potentially be deployed for other types of logical communication links. This sort of arrangement is also intended for inter-AS routing, and would increase overall costs if deployed for metro and access networks or other types of operational/administrative sub-domains that are within the same MS-PW operational domain.

Embodiments of the invention may thus be particularly suited for MS-PW operational domains for which an incremental increase in routing functionality above simple statically placed virtual connections, illustratively MS-PWs, is desired, but exterior protocols and PCE-type arrangements are not feasible. In these cases, it may be possible to leverage mechanisms of a PSN IGP to distribute MS-PW routing information, for example.

In accordance with some embodiments, extensions to OSPF are used to enable automatic advertisement of PW Layer 2 addresses by routing apparatus in multiple operational/administrative sub-domains within a single AS. This in turn enables automatic routing, by routing apparatus, of MS-PWs across multiple OSPF domains in an OSPF AS.

The proposed OSPF protocol extensions and other aspects of the present invention are applicable at least to domains where MP-BGP is not used or is not desired to be used for dynamic placement of MS-PWs. In many cases, this will apply to routing MS-PWs across a single MS-PW operational domain, where a source T-PE (ST-PE), a Target T-PE (TT-PE) and all of the intermediate S-PEs reside in the same AS. However, this does not preclude cases where OSPF is used to route one portion of a MS-PW across a given AS where the ST-PE and the TT-PE reside in different ASs. Here, OSPF could be used to advertise destinations that are reachable through S-PEs corresponding to ASBRs. This would enable ingress S-PEs and intermediate S-PEs in an AS to route MS-PWs to the correct egress S-PE in the AS to reach a TT-PE in another AS. Thus, the techniques disclosed herein might be used within an MS-PW operational domain for one or more segments of a multi-segment logical communication link that extends outside the MS-PW operational domain.

Distributed information can be used by routing apparatus, such as the T-PEs and S-PEs in FIG. 3, to derive MS-PW routing tables. These routing tables are used in some embodiments to signal the next-hop S-PE or T-PE in order to dynamically route PWs, which may be segments of an MS-PW.

The logical topology overlay model shown in FIG. 3 represents the existence of control signalling adjacencies between T-PE/S-PE, S-PE/S-PE and S-PE/T-PE. One example of a signalling adjacency is a T-LDP session used in MS-PW signalling. A pair of routable IP addresses is used in some embodiments to represent and distribute this signalling adjacency. Each S-PE/T-PE and attachment circuit can also be assigned its own Layer 2 address in the form of an Attachment Individual Identifier (AII). Those skilled in the art will be familiar with AIIs.

When an adjacency is to be used for the establishment of a PW or a PW segment, a PE that terminates one end of an adjacency can advertise a set of the AIIs that are reachable at that PE. Type 2 AIIs could be used for this purpose. Summarized AIIs might instead be used to avoid separate advertisements for every AC reachable via an adjacency.

In establishing a virtual connection such as a PW using a logical communication link, a T-PE may select a known specific path along a set of S-PEs. In the case of PWs as the virtual connections, for example, each S-PE should be uniquely addressable in terms of PWs. For this purpose, at least one AII address having a format similar to a Type 2 AII, composed of a Global ID and Prefix, could be assigned to each S-PE. The Prefix can be derived from the S-PE address associated to the locally assigned routable address, for instance.

A virtual connection routing advertisement can thus model a set of PE nodes, with signalling adjacencies, and a set of AIIs associated with each node. The resulting topology is a connected graph that identifies each AII routeable within the MS-PW operational domain, each S-PE, such as by an AII that includes its IP address, a set of logical communication links that can be used to selectively establish virtual connections such as PWs between PEs, and each T-PE, such as by one or more AIIs containing an IP address for the T-PE. Based on this topology, each T-PE and S-PE can build a routing table containing all routable AIIs. When creating a PW or a PW segment of an MS-PW, the PE can look up the AII and determine the next hop PE by identifying a path toward the TT-PE for the AII through S-PE routers and their available logical communication links. A logical link to the next hop PE can then be used to establish a virtual connection such as a PW segment through LDP or Resource reSerVation Protocol (RSVP) signalling, for example.

These and other aspects of the present invention will be described in further detail below.

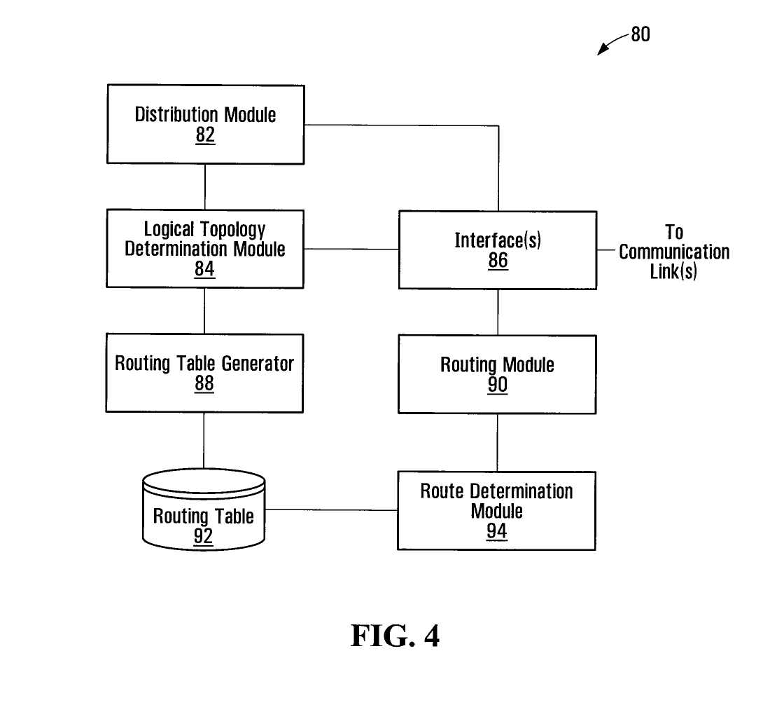

FIG. 4 is a block diagram of a routing apparatus. In accordance with one embodiment of the invention, a routing apparatus 80 includes a distribution module 82, a logical topology determination module 84 operatively coupled to the distribution module, a routing table generator 88 operatively coupled to the logical topology determination module, a memory 92 operatively coupled to the routing table generator for storing a routing table and/or possibly other information for computing an on-demand routing path, a route determination module 94 operatively coupled to the memory 92, a routing module 90 operatively coupled to the route determination module, and one or more one or more interface(s) 86 operatively coupled to the distribution module, to the logical topology determination module, and to the routing module.

A communication network routing apparatus may include other components in addition to those shown in FIG. 4. It should be appreciated that only components involved in logical communication link and virtual connection functions have been explicitly shown in the routing apparatus 80. It should also be appreciated that not all of the components shown in FIG. 4 need necessarily be provided in every embodiment of the invention. Thus, the routing apparatus 80 is representative of one illustrative embodiment of the invention. Other embodiments may be implemented using further, fewer, or different components than shown in FIG. 4, with similar or different interconnections.

The types of connections through which the components of FIG. 4 are operatively coupled may, to at least some extent, be implementation-dependent. Communication equipment components often use various types of physical connectors and wired connections such as midplane and backplane conductors, although the present invention is in no way limited to wired connections. In the case of cooperating software functions, for example, an operative coupling may be through variables or registers, and thus be an indirect coupling rather than a direct physical coupling. Components may also be otherwise indirectly physically coupled to each other. For example, the routing module 90 is indirectly coupled to the logical topology determination module 84, through the route determination module 94, the memory 92, and the routing table generator 88. These indirectly coupled components can still be considered to be operatively coupled in the sense that the routing module 90 may dynamically route virtual connections based on topology information that is collected by the logical topology determination module 84, as described below.

The interface(s) component 86 represents one or more interfaces, and possibly interfaces of multiple different types, that enable the routing apparatus 80 to communicate with other components of a communication system. For example, the distribution module 82, the logical topology determination module 84, and the routing module 90 may interact with other communication system components to perform such functions as detecting and advertising logical link signalling adjacencies and establishing virtual connection. Although only a single interface(s) component 86 is shown in FIG. 4, the modules 82, 84, 90 need not necessarily be connected to the same interface or interfaces.

For example, the routing module 90 might exchange control information with routing modules in other routing apparatus through a signalling interface, whereas the distribution module 82 and the logical topology determination module 84 might use data or traffic interfaces, possibly in addition to the signalling interface, in performing their functions. In general, the number and types of interfaces, and also their connection(s) to other components and to other routing apparatus, may vary depending on the communication system and communication equipment in conjunction with which the apparatus 80 is implemented. Those skilled in the art will be familiar with many such interfaces and their operation.

One or more memory devices may be used to implement the memory 92. Solid state memory devices are common in communication equipment, although other types of memory devices, including devices for use with movable or even removable storage media, may also or instead be used. A routing table is shown in FIG. 4 as an example of one form in which logical topology information might be stored. It should be appreciated that logical topology information could also or instead be stored in one or more memory devices in the form in which it is collected, and not only or necessarily in a processed form as a routing table. A link state database is one example of a data store in which logical topology information could be installed or otherwise stored in the memory 92 or possibly in another memory element.

As described in further detail below, the logical topology determination module 84 and the distribution module 82 collect and distribute virtual connection and logical link signalling and routing information. Based on locally collected information and information received from other routing apparatus, the routing table generator 88 can generate a routing table. The route determination module 94 can then determine a route for a virtual connection, when a setup message or other form of virtual connection request is received, for instance, and the routing module 90 causes that virtual connection to be established. At least these components may be implemented using hardware, firmware, software for execution by one or more processing elements, or some combination thereof. Any or all of devices such as microprocessors, microcontrollers, Programmable Logic Devices (PLDs), Field Programmable Gate Arrays (FPGAs), Application Specific Integrated Circuits (ASICs), Network Processors (NPs), and other types of “intelligent” integrated circuits may be suitable for this purpose.

Given the many possible options for implementing the modules 82, 84, 90, 94 and the routing table generator 88, these components are described herein primarily in terms of their functions. Based on the functional descriptions, a person skilled in the art will be enabled to implement techniques according to embodiments of the invention in any of various ways.

The logical topology determination module 84 is operable to identify a logical communication link, and all such links in some embodiments, that is capable of being used to establish a virtual connection between the routing apparatus 80 and other routing apparatus within a virtual connection operational domain of an underlying communication link in the communication system. A destination that is associated with the routing apparatus 80 and is reachable through the virtual connection is also identified by the logical topology determination module 84. It is expected that all reachable destinations will be identified by the logical topology determination module in most implementations. Destinations identified by the logical topology determination module 84 may include, for example, the routing apparatus 80 itself and each attachment circuit through which the routing apparatus 80 communicates with equipment, such as customer premises communication equipment, other network elements, etc.

These functions of the logical topology determination module 84 may involve identifying signalling adjacencies based on locally available information and/or information received from other routing apparatus. For a local determination, the logical topology determination module 84 might access configuration information in a memory (not shown) to identify signalling sessions, illustratively T-LDP sessions, that are currently operationally “UP”. These sessions represent signalling adjacencies between routing apparatus, and can be used to establish virtual connections such as PWs for exchanging communication traffic with other routing apparatus.

As the sessions are created, deleted, become operationally “UP” or stop being operationally “UP”, or are affected by other events such as traffic engineering data updates for instance, the logical topology determination module 84 may collect information from other modules such as one or more of the interface(s) 86, the distribution module 82, the routing table generator 88, and possibly other logical topology determination modules. The logical topology determination module 84 can then adjust the logical topology, immediately or with any type of a delay that limits frequency of change propagation, for example, based on adjacency up/down de-bounce timers, amount of changes required to issue a new advertisement, etc., and provide it to the routing table generator 88, and/or, through the distribution module 82, to other logical topology determination modules. Similar functionality may be provided for AII address changes as well.

The logical topology determination module 84 may also or instead interact with other routing apparatus to determine its local topology. For example, where automatic discovery is supported, the logical topology determination module 84 might receive an announcement or other message from an adjacent switching-capable PE that is added to a virtual connection operational domain.

Destinations associated with the routing apparatus 80 may also be identified in any of various ways, based on local configuration information and/or on information that is exchanged with a destination.

The distribution module 82 provides information, which is indicative of the identified logical communication link and of the identified destination, for distribution in multiple sub-domains within the virtual connection operational domain. If multiple logical communication links and/or destinations are identified, then this information could be indicative of each logical communication link and of each destination. Information relating to different logical links and destinations could potentially be advertised separately.

The distribution module 82 may receive logical topology information from the logical topology determination module 84, format that information for distribution within the virtual connection operational domain, and distribute the information to other routing apparatus through an interface 86. It should be appreciated, however, that such reformatting might not be performed in all embodiments. The logical topology determination module 84 might collect topology information and output that information to the distribution module 82 in an appropriate format for distribution. The distribution module 82 then forwards the information to other routing apparatus without performing a reformatting operation.

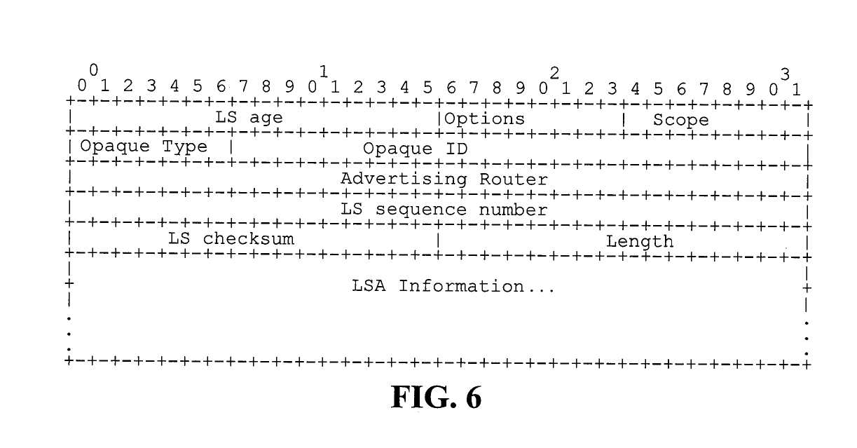

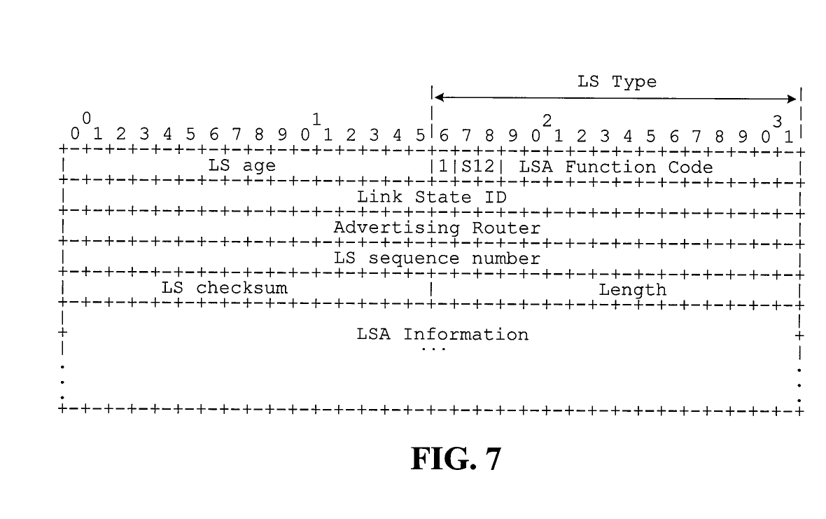

In one embodiment, the distributed information is in the form of an OSPF LSA. Examples of such an LSA are described below with reference to FIGS. 6 and 7.

The logical topology determination module 84 and the distribution module 82 thus cooperate, with each other and possibly other components, to detect and distribute signalling adjacencies. The logical topology over which virtual connections can actually be signalled will generally be a subset of all the local logical topologies at each routing apparatus. For example, PW segments can be signalled over a topology that is a subset of an MS-PW topology. However, it should also be appreciated, as noted above, that a logical topology might not include an entire underlying communication system. In the case of PseudoWire Emulation Edge-to-Edge (PWE3) signalling for instance, a PWE3 logical topology generally coincides with the topology of PWE3 control protocol (i.e., PW signalling) adjacencies. That is, not all PEs can be S-PEs, and not all S-PEs can be assumed to be capable of dynamic PW routing.

Consider an illustrative example of a PW as a virtual connection that can be established using a logical communication link. In order to use a given signalling session to a peer S-PE/T-PE to signal inter-domain PWs such as dynamically placed MS-PWs, S-PEs/T-PEs determine which PEs along a path to reach an intended destination are switching capable PEs. The following procedure is used in some embodiments to establish this association.

T-PEs/S-PEs that are switching capable announce or otherwise distribute this capability, such as in a TLV triplet of an OSPF LSA. As described in further detail below, a PW Adjacency TLV in a PW Switching LSA may be used for this purpose. To further optimize this embodiment, the PW Adjacency TLV might contain only configured adjacencies that are currently operationally up for an advertising routing apparatus and meet local advertisement criteria such as specific operational/administrative sub-domains within a single virtual connection operational domain, traffic engineering requirements, etc. The logical topology determination module 84 of a T-PE/S-PE associates the originator of the LSA with the endpoint of one of its own signalling sessions (either directly or through another PW Adjacency TLV in the case of multi-hop switching). In a single hop case, this may be achieved automatically by matching router IP addresses in an LSA with signalling endpoints, or by configuration.

A PW Adjacency TLV is one example of logical topology information that is indicative of signalling adjacencies, such as T-LDP sessions, that are currently configured and operationally up.

Such signalling adjacencies may be maintained, by the logical topology determination module 84 or another component of the routing apparatus, using a signalling protocol-specific mechanism such as LDP “hello” messages. Changes in the state of a signalling adjacency can thereby be detected by the logical topology determination module 84 and distributed. The logical topology determination module 84 may itself detect a change in link state or be advised of a change in link state where a peer S-PE or T-PE at the remote end of a signalling session does not respond to a “hello” message or other maintenance signal. An updated PW Adjacency TLV could be included within a PW Switching LSA when a signalling adjacency goes down, for instance. Any of various mechanisms, such as de-bounce timers and others noted herein, may be implemented by the distribution module 82 in order to reduce the number of advertisements in the event of a “bouncing” signalling adjacency.

The logical topology determination module 84 may thus determine a local logical topology including a set of one or more signalling adjacencies, illustratively PW signalling sessions, that may be used for signalling logical links such as dynamically placed MS-PWs, and, in the case of T-PEs, a set of one or more destinations. Destinations may be distributed in PW Switching LSAs, as AII TLV triplets for instance. AII TLVs associate end-point destinations with respective adjacencies that are providing access to the end-points. Again techniques to minimize the amount of data advertised and the frequency of advertisements may be used similar to, or possibly different from, those employed in adjacency advertisement.

Logical topology information is distributed within an MS-PW operational domain by flooding in some embodiments. Flooding can perhaps be most clearly illustrated in the context of an illustrative example of an OSPF LSA.

According to an embodiment of the invention, OSPF routers that receive PW Switching LSAs forward these LSAs according to the rules of OSPFv2 or OSPFv3, as applicable. As noted above, a logical overlay topology might not necessarily include all NEs in an underlying communication system. Some PE or P routers, for example, might not be capable of MS-PW switching, but should ideally process and forward received PW Switching LSAs as required by the OSPF protocol to ensure that no part of a logical topology is isolated when any physical links in an underlying communication system go down.

S-PEs, T-PEs, and all other PE/P routers that are OSPF routers and that receive PW switching LSAs not only forward them according to the rules of OSPFv2 or OSPFv3, but also process the received LSAs. The distribution module 82 and/or the logical topology determination module 84 may be involved in this process as well. In addition to collecting and distributing local logical topology information at a routing apparatus, the logical topology determination module 84 might also receive, from the distribution module 82 or directly from an interface 86, logical topology information that is distributed by other routing apparatus.

Information that is indicative of a local logical topology may be stored in a memory by the logical topology determination module 84, in addition to being distributed by the distribution module 82. A locally generated PW Switching LSA could be stored in a PW link state database, for example. This database could be stored in the memory 92 or in a different memory area or device (not shown), as noted above. Logical topology information received from remote routing apparatus may also be stored in the same link state database. Such a link state database would then represent a connected graph of S-PEs and T-PEs, and may be used by the routing table generator 88 to build a PW routing table. Examples of mechanisms for generating PW routing tables and the structure thereof will be apparent to those skilled in the art. Although the present invention is not restricted to any particular algorithm for generating a PW routing table from a link state database, it is generally expected that all T-PEs and S-PEs within a virtual connection operational domain will use the same algorithm for the same service.

For a virtual connection switching capable routing apparatus, a routing table stored in the memory 92 may be accessed by the route determination module 94 to identify a logical communication link that can be used to establish a virtual connection toward a destination. The routing module 90 can then dynamically route a virtual connection toward the destination, possibly in accordance with predetermined and/or configurable routing constraints. Actual establishment of a virtual connection may involve signalling an adjacent routing apparatus, or the exchange of control signalling between signalling apparatus or components associated with routing apparatus between which a virtual connection is to be established. This signalling may be handled by the routing module 90 itself in some embodiments, or by a separate signalling component or apparatus with which the routing module interacts. The routing module 90 may, for example, provide routing information to a signalling component or apparatus (not shown). The routing module 90, and accordingly the routing apparatus 80, may thus cause a virtual connection to be established either by establishing the virtual connection itself or through interaction with other components or apparatus responsible for establishing virtual connections. References herein to causing virtual connections to be established should be interpreted to include any of these options for establishing virtual connections.

In the case of a multi-segment virtual connection such as an MS-PW, a virtual connection is actually one segment of a virtual connection.

For PW routing, the route determination module 94 uses the routing table to determine the next signalling hop toward an intended destination. A T-PE might initiate a PW setup message to the next hop S-PE, as determined by the route determination module 94, when a virtual connection to a destination is to be established. At the next hop S-PE, when the PW setup message is received, the route determination module 94 determines a subsequent hop S-PE or T-PE. This process may be repeated at multiple S-PEs along a route between an ST-PE and a TT-PE.

Static PW routes may also be provisioned in some embodiments or may be mixed with dynamic MS-PW establishment, where multiple dynamically established MS-PWs are further joined through static MS-PW “stitching”. Therefore, it should be appreciated that deployment of dynamic routing at a routing apparatus in accordance with embodiments of the invention does not necessarily preclude any existing routing functions.

Dynamic routing can perhaps best be illustrated by considering more detailed comparative examples. In a single sub-domain static routing case in an MPLS network, PEs distribute PW labels either on demand or unsolicited, as is more common, using FECs. These labels represent AIIs locally on a PE. The PEs have PW adjacencies in the form of T-LDP sessions, which as those skilled in the art will appreciate are connectionless IP session between two routers. There will also be one or many MPLS tunnels, established through LDP or RSVP, between the PEs. Each MPLS tunnel is represented by a label as well, although an MPLS tunnel label is a different type of label than a PW label.

When a PW is to be established between two AIIs off two PEs, the PEs exchange PW signalling information in the form PW labels associated with the AII address at each PE over the T-LDP session between those PEs. Each PE then adds to the packets it sends on the PW the PW label it received from the other PE (i.e., an inner label) and a locally determined tunnel label for the MPLS tunnel between the PEs (i.e., an outer label). The tunnel label is used to forward the packet between the PEs, and is stripped before the local PW processing takes place at the receiving PE. As part of that local processing, the inner label is then used to forward data on the PE towards the destination AII.

A PW is thus established in this example by using information, provided through logical T-LDP links, that allows placing of packets into MPLS tunnels to establish a virtual connection by means of label assignments.

In this sense, T-LDP sessions can be considered a logical overlay for a PW-capable network. The above example of an MPLS network further illustrates that underlying communication links over which connections are established, MPLS tunnels in this example, can also be or include logical links. An MPLS network is another form of a logical overlay that is established over a physical network or a subset thereof.

For statically provisioned MS-PWs, each PE is notified through configuration as to the next hop T-LDP session to be used. Each PE relies on other segments to be established and on switching points being able to handle label swapping to pass traffic from one tunnel of one segment to another tunnel of the subsequent segment. This is all configured statically where dynamic routing is not supported.

According to an embodiment of the invention, an ST-PE is not statically configured to use any particular first hop T-LDP session. Instead, the route determination module 94 of the ST-PE determines the intended destination, illustratively a TT-PE AII, and tries to identify a router that advertised the AII or a prefix to the AII if aggregated addresses are advertised. This might involve consulting a routing table and/or a link state database in the memory 92, for example.

If the advertising router is identified, then the ST-PE has either a T-LDP session with that router, in which case the route determination module 94 selects the T-LDP session to be used by the routing module 90 to exchange label mappings with the router, or a path of T-LDP sessions to the router. By tracing a path of logical links between routers, T-LDP sessions in this example, from the TT-PE that advertised the destination AII to the ST-PE, the route determination module 94 can identify candidate T-LDP sessions with S-PEs and select a particular T-LDP session with an S-PE to be used to establish a virtual connection toward the destination AII. There may be multiple candidate LDP sessions, and in this instance any of various criteria might be used to select one of those sessions. The routing module 90 then uses the selected T-LDP session to initiate the label mapping exchange for the first hop. This also triggers the above process recursively until a connection segment endpoint S-PE has a direct T-LDP session to the TT-PE.

The TT-PE returns a local PW label mapping for the destination AII to the last S-PE. The S-PE stores the label and then returns to the previous S-PE its local label mapping for the next connection segment toward the ST-PE. This is repeated all the way until first hop S-PE returns to the ST-PE a label mapping for the first hop along the path. In this manner, both directions of a connection are established separately but at substantially the same time.

It should be noted that routing is completed at each PE by determining an MPLS tunnel label for the underlying MPLS tunnel of the MS-PW segment often before the label mapping is forwarded to the next hop. The ST-PE puts both a tunnel label and an inner label on each packet of communication traffic it sends towards the first S-PE. When such a packet is received, the S-PE removes tunnel label, unless it was stripped by a directly preceding node as may be the case where the MPLS tunnel traverses intermediate nodes in the underlying communication system. The inner label is used to “cross-connect” the packet to the next hop tunnel, the label of which would already be known at the receiving S-PE in this example. This process continues at each S-PE until the packet is received by the TT-PE, which uses inner label it provided during the above example setup sequence to determine the AII to which the packet is to be forwarded.

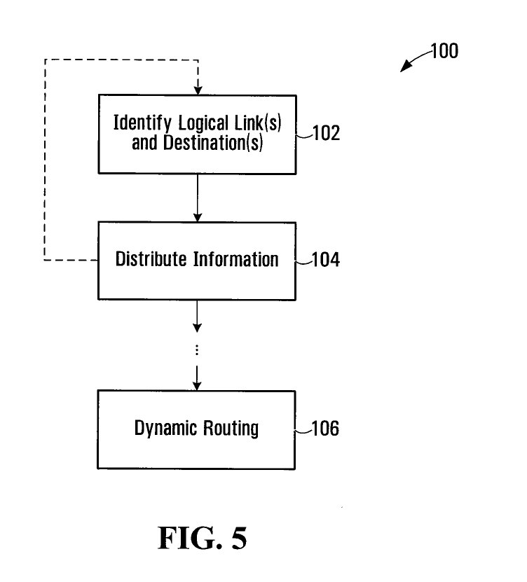

FIG. 5 is a flow diagram of a method of managing virtual connections using logical communication links. The method 100 includes an operation 102 of identifying logical communication link(s) and destination(s) at a routing apparatus. This involves identifying at least one, and possibly each, logical communication link that is capable of being used to establish a virtual connection, with other routing apparatus within a virtual connection operational domain of an underlying communication system, and identifying each, or at least one, destination that is associated with the routing apparatus and is reachable through the or each virtual connection. Logical communication links may be identified, for example, by determining other routing apparatus with which the routing apparatus has a signalling adjacency.

Information that is indicative of one or more of the identified logical communication link(s) and of one or more of the identified destination(s) is then provided at 104 for distribution to another operational/administrative sub-domain, and possibly multiple operational/administrative sub-domains, within the virtual connection operational domain. Logical link information might include information identifying each other routing apparatus with which the routing apparatus is capable of establishing a virtual connection, for instance. In one embodiment, the information is provided as one or more OSPF LSAs.

The method 100 also includes a dynamic routing operation 106, which entails the routing apparatus actually causing a virtual connection to be established using a logical communication link. This may involve exchange of control signalling by signalling components over the logical communication link, for example, as noted above.

It should be appreciated that the method 100 is illustrative of one embodiment of the invention. Variations of the method 100 are also contemplated. For example, as illustrated by the dashed arrow in FIG. 5, link and destination identification at 102 and distribution of resultant logical topology information at 104 may be an ongoing process, to ensure that logical topology information is accurate and updated as necessary. Logical topology information may also be stored, received from other routing apparatus, and/or processed to build a routing table.

In general, methods according to other embodiments may include further, fewer, or different operations, performed in a similar or different order, than shown in FIG. 5. Examples of such operations, and various ways in which operations may be performed, will be apparent from the foregoing description of FIGS. 1 to 4. Considering the overall operation of a communication system for instance, a method according to another embodiment of the invention might involve establishing a logical overlay topology within a communication system virtual connection operational domain that includes multiple operational/administrative sub-domains, advertising the logical overlay topology within the virtual connection operational domain, identifying at a routing apparatus in one of the operational/administrative sub-domains logical communication links, in the logical overlay topology, that are capable of being used to establish virtual connections toward a destination in another one of the operational/administrative sub-domains, and selecting an identified logical communication link to be used to establish a virtual connection toward the destination.

Further variations of the method 100 may be or become apparent to those skilled in the art.

Embodiments of the invention have been described above primarily in the context of apparatus and systems. However, aspects of the invention may also be embodied in other forms, including data structures. FIGS. 6 and 7 are block diagrams of advertisements for distributing information associated with logical communication links and destinations, and represent examples of such data structures. A data structure may, in addition to being encoded, modulated, or otherwise incorporated into a signal or other form of physical carrier for distribution, also be stored in a link state database or other data store.

As noted above, logical topology information may be distributed in LSAs in some embodiments. OSPF provides opaque LSAs that may be suitable for this purpose where routers, including PE and intermediate P routers, that support opaque LSA processing exist along a flooding path in a virtual connection operational domain. This ensures propagation of logical topology information for dynamic routing of virtual connections. In some implementations, multiple opaque LSA flooding paths may exist in a virtual connection operational domain. This would improve the resiliency and reliability of logical topology information distribution, in that failure of a router along a flooding path would not necessarily isolate a portion of a virtual connection operational domain.

In accordance with OSPF specifications, routers that support opaque LSA processing will flood received opaque LSAs even if they do not “understand” the content of those LSAs. Thus, an interior gateway protocol can be used, illustratively in an IP network or other PSN, to advertise routing information for dynamic routing and automatic placement of logical communication links such as MS-PWs regardless of whether the functionality for MS-PWs is used or supported by a router that is part of the network. This adds to resiliency but may result in congestion in the routing plane of the PSN if a large number of LSAs are flooded.

The impact of this additional flooding load may be reduced, for example, through such mechanisms as aggregation of AIIs and/or limiting the number of updated LSAs in the event of link state changes. Other techniques may also or instead be used to avoid routing congestion. For instance, separate IGP instances could be used for the underlying PSN and for logical topology LSAs. A priority scheme might prioritise PSN LSAs over PW Switching LSAs. Rate limiting could be applied to PW Switching LSAs so that they do not consume excessive bandwidth or router processor capacity. OSPF Refresh and Flooding reduction mechanisms have also been defined in RFC-4136, referenced above.

Any of these mechanisms, and possibly others, can reduce the overall impact of LSA flooding.

The PW Switching LSA, which has been briefly described above, is a new LSA that is defined in accordance with one aspect of the present invention. This LSA describes S-PEs/T-PEs, as well as logical communication links between S-PEs and T-PEs or between peer S-PEs. As described in further detail below, OSPF routers behaving as S-PEs or T-PEs may advertise destinations, illustratively in the form of Layer 2 addresses, that are reachable through them. This advertisement is in an AS-scoped opaque LSA in some embodiments.

The format of an OSPFv2 opaque LSA is shown in FIG. 6. It should be appreciated that this format, and similarly other data structure formats shown in the drawings and described herein, are intended as illustrative and non-limiting examples of possible data formats that may be used in implementing embodiments of the invention. Alternative data formats may include further, fewer, or different data fields, of similar or different sizes, arranged in a similar or different order.

Those skilled in the art will be familiar with OSPFv2 opaque LSAs of the form shown in FIG. 6. The illustrated LSA includes a 20-byte header and an LSA Information field.

In the LSA header, the LS age field indicates the time in seconds since the LSA was originated by its advertising router. The Options field allows a router to communicate to other routers its capabilities to support optional functions, as described in the above-referenced RFC-2370. In this field, at least the “O” bit is set to 1, to indicate that the advertising router will receive and forward opaque LSAs. The Scope field sets the flooding scope of the LSA, and for the purposes of distributing logical topology information, would be type 11 (AS-wide). The Scope field is an example of distribution information for causing logical communication link information and destination information to be distributed from one operational/administrative sub-domain to another operational/administrative sub-domain within a virtual connection operational domain.

The Opaque Type field and Opaque ID field identify the LSA to be of type PW Switching. Since those fields are new types proposed to implement embodiments of the invention, their values are not defined in current OSPF specifications. The values used in those fields distinguish PW Switching LSAs used for dynamic placement of MS-PWs from other opaque LSA types. Those skilled in the art will appreciate that the assignment of new opaque LSA types may involve review and approval by an authority such as the Internet Assigned Numbers Authority (IANA) or by a designated expert. Therefore, the present invention is in no way restricted to any specific value of the Opaque Type and Opaque ID fields. Those skilled in the art will recognize that although Opaque Type and Opaque ID values have not currently been set for PW Switching LSAs, any values, or any other mechanism that would enable an LSA to be distinguished as a PW Switching LSA could be used.

An identifier of the router that originates the opaque LSA is provided in the Advertising Router field. This identifier is the OSPF router ID of the originating router in the example shown in FIG. 6. This router ID could also potentially be set in the Opaque ID field since a PW Switching LSA describes the local logical topology for the advertising router.

The LS Sequence Number field includes a sequence number that is set by the advertising router, and is used to detect old and duplicate LSAs. The LS checksum field holds a checksum of the contents of the LSA, including the LSA Information field and all header fields except the LS age field. The Length field indicates the length in bytes of the entire LSA, including the complete 20-byte header.

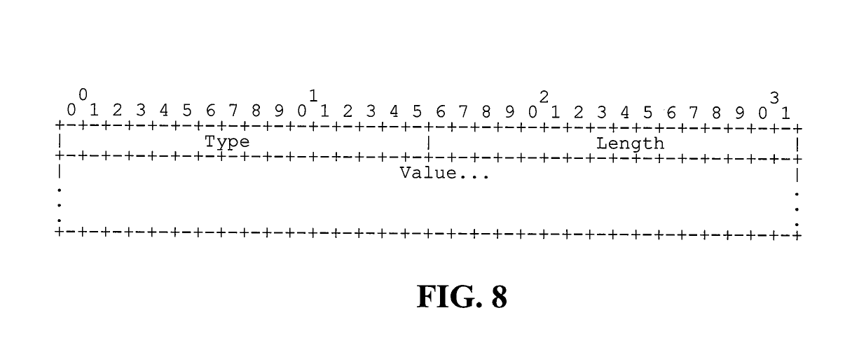

Logical topology information is included in the LSA Information field. This field includes at least logical communication link information indicative of a logical communication link that is capable of being used to establish a virtual connection between the advertising router and other routing apparatus within a virtual connection operational domain of a communication system, and destination information indicative of a destination that is associated with the routing apparatus and is reachable through the virtual connection. The logical communication link information and the destination information enable dynamic routing of a virtual connection toward the destination by the other routing apparatus. Illustrative examples of LSA Information field content are described below with reference to FIG. 8.

Referring first to FIG. 7, a further example of an LSA is shown. This LSA would be applicable to OSPFv3.

The OSPFv3 LSA of FIG. 7, like the OSPFv2 LSA of FIG. 6, includes an LS age field, an Advertising Router field, an LS sequence number field, an LS checksum field, a Length field, and an LSA Information field. However, as will be apparent from a comparison of FIGS. 6 and 7, the OSPFv3 LSA header has a different format of fields following the LS age field.

In the OSPFv3 LSA header, a 16-bit LS Type field indicates the function of the LSA. As described in the above-referenced RFC-2740, The three higher-order bits, including a U bit and S1 and S2 bits, encode generic properties of the LSA, and the remaining 13 bits, called the LSA Function Code, indicate the specific functionality of the LSA. As shown, the U bit is set to one, so that routers that do not recognize the LSA Function Code will flood the LSA. The S1, S2 bits are set to (1, 0) to indicate an AS flooding scope for the LSA, and these bits represent another example of distribution information that controls distribution of logical communication link information and destination information between sub-domains within a virtual connection operational domain.

As for some fields of the example LSA in FIG. 6, particular values in the header fields of the LSA in FIG. 7 have not yet been set, and the present invention is not limited to any specific values for allowing an LSA to be distinguished as a PW Switching LSA.

The LSA Information fields in the LSAs of FIGS. 6 and 7 may be formatted in a similar manner. Both include logical communication link information and destination information. In one embodiment, the LSA Information field includes two or more nested TLV triplets. FIG. 8 is a block diagram of an example format of a TLV. TLVs will be familiar to those skilled in the art, and as shown in FIG. 8, include a Type field indicating a type of the TLV, a Length field indicating a length of the Value field, and the Value field itself. Within the Value field, contents could be formatted into one or more sub-TLVs.

An OSPF router may have a routing address that is different from its OSPF ID. Therefore, an LSA Information field may include a TLV for the routing address, such as an IP address, of the advertising router. For OSPFv2 routers, this could be the Router Address TLV defined RFC-2370, for example. A Router IPv6 Address TLV has also been defined for OSPFv3 routers in the above-referenced Internet Draft entitled “Traffic Engineering Extensions to OSPF version 3”, and may be included in the LSA Information field of an LSA originated by an OSPFv3 router. In each of these cases, the Value field in the routing address TLV is set to the IP address of the advertising T-PE or S-PE.

Two additional TLVs are also proposed for implementing embodiments of the invention. These include an AII TLV and a PW Adjacency TLV. Each of the new TLVs would be assigned new Type numbers to identify the TLVs. However, the present invention is not restricted to any specific assignment of Type number nor to the format of the TLVs. For example, a single TLV combining both link and destination information may be used as well.

If a TLV in the LSA Information field is of type AII, then the Value field contains destination information, illustratively in the form of a Type 2 AII. A respective TLV could be included in an LSA for each destination, although as noted above summarized AIIs are also contemplated and may be desirable in some implementations. In a nested TLV structure, an AII TLV might include in its Value field respective sub-TLVs for further characteristics of each advertised destination.

The PW Adjacency TLV is used to describe the presence of a PW signalling adjacency between two S-PEs or between an S-PE and a T-PE. In one embodiment, the PW Adjacency TLV contains two sub TLVs. An advertising PE Layer 2 Address sub-TLV includes the AII Type 2 address of the advertising PE router, whereas a Remote PE Layer 2 Address TLV includes the AII Type 2 address of the remote PE at the far end of the PW signalling session. Other embodiments may, for example, combine this information into a single TLV without using sub TLVs.

The LSA and TLV examples described above illustrate one possible format in which logical topology information could be distributed between different operational/administrative sub-domains within an MS-PW operational domain. The PW Adjacency TLV represents an example of logical communication link information that includes respective TLV triplets comprising, for each logical communication link, an address of an advertising routing apparatus and an address of a remote routing apparatus with which a virtual connection can be established using the logical communication link. The AII TLV similarly represents an example of a form in which an address of each destination could be distributed.

Some embodiments of the invention as disclosed herein may involve extensions to OSPF to enable the automatic advertisement of summarized PW FECs between different operational/administrative sub-domains within an MS-PW operational domain, thus enabling the automatic routing of MS-PWs across an OSPF domain. Specific OSPF extensions as described above may be used to provide for advertisement of Attachment Circuit Addressing (AIIs) for addresses that are reachable across an OSPF AS, illustratively in AII TLVs within PW Switching LSAs, advertisement of PW signalling topology including PW adjacencies, such as in PW Adjacency TLVs within PW Switching LSAs, and/or generation of routing tables from distributed information for dynamically routing MS-PWs.

Based on the teachings provided herein, it will be apparent to those skilled in the art how to extend the present invention to other IGP protocols such as IS-IS for instance. As proposed for OSPF, IS-IS extensions could be used in a substantially similar manner. One of the documents referenced above relates to IS-IS extensions, and accordingly a person skilled in the art could use or modify these extensions or potentially use other extensions to implement embodiments of the invention for IS-IS.

Configuration overhead required to establish PWs may also be reduced by implementing the techniques disclosed herein. Utilizing relatively small extensions to existing interior routing protocols, dynamic routing within a single virtual connection operational domain can be achieved.

Network robustness can also be potentially improved by making PW establishment dynamic and less prone to manual configuration errors.

What has been described is merely illustrative of the application of principles of embodiments of the invention. Other arrangements and methods can be implemented by those skilled in the art without departing from the scope of the present invention.

For example, although OSPF is discussed in detail herein, similar extensions may apply to other protocols such as other IGP protocols including IS-IS for instance. Other illustrative examples should similarly be interpreted in a non-limiting manner. A PW is one type of virtual connection that can be established for communication traffic transfer using logical communication links. The techniques disclosed herein, however, may also be applicable to other types of virtual connections.

The divisions of functions shown in the drawings and described above are also intended to be illustrative and non-limiting. Embodiments of the invention may be implemented using further, fewer, or different functional elements than considered above.

The specific form and/or content of distributed information may similarly vary between embodiments of the invention. Logical communication link information, for example, might identify not only T-LDP adjacencies but also any of various properties of those adjacencies. Destination information may similarly specify one or more properties of each destination in addition to their addresses.

In addition, although described primarily in the context of methods and systems, other implementations of the invention are contemplated, as instructions stored on a computer-readable medium, for example.

We claim:

1. A communication traffic routing apparatus comprising:
a logical topology determination module operable to identify a logical communication link that is capable of being used to establish a virtual connection between the routing apparatus and another routing apparatus within a virtual connection operational domain of an underlying communication system, the virtual connection operational domain comprising multiple sub-domains, and to identify a destination that is associated with the routing apparatus and is reachable through the virtual connection; and
a distribution module operatively coupled to the logical topology determination module and operable to provide information, which is indicative of the identified logical communication link and of the identified destination, for distribution from a sub-domain of the routing apparatus in the virtual connection operational domain to another sub-domain within the virtual connection operational domain.

2. The routing apparatus of claim 1, wherein the logical topology determination module is operable to identify a logical communication link by determining another routing apparatus with which the routing apparatus has a signalling adjacency.

3. The routing apparatus of claim 1, wherein the logical topology determination module is operable to identify an attachment circuit of the routing apparatus as a destination that is associated with the routing apparatus and is reachable through the virtual connection.

4. The routing apparatus of claim 2, wherein the information indicative of the identified logical communication link comprises information identifying the other routing apparatus.

5. The routing apparatus of claim 1, wherein the virtual connection comprises a PseudoWire.

6. The routing apparatus of claim 1, wherein the information comprises a message of an Interior Gateway Protocol (IGP).

7. The routing apparatus of claim 6, wherein the Interior Gateway Protocol comprises a protocol selected from the group consisting of: Open Shortest Path First (OSPF) protocol and Intermediate System to Intermediate System (IS-IS) protocol.

8. The routing apparatus of claim 1, further comprising:
a routing module operatively coupled to the logical topology determination module and operable to cause the virtual connection to be established using the identified logical communication link.

9. The routing apparatus of claim 8, wherein the routing module is operable to cause the virtual connection to be established as a segment of a multi-segment virtual connection.

10. The routing apparatus of claim 1, wherein the logical topology determination module is further operable to receive from another routing apparatus in the virtual connection operational domain information indicative of a logical communication link that is capable of being used to establish a virtual connection with the other routing apparatus and of a destination that is associated with the other routing apparatus and is reachable through the virtual connection with the other routing apparatus.

11. The routing apparatus of claim 10, further comprising:
a routing table generator operatively coupled to the logical topology determination module and operable to generate a routing table based on the identified logical communication link, the identified destination, and the information received from the other routing apparatus.

12. The routing apparatus of claim 1, wherein the logical communication link comprises a Targeted Label Distribution Protocol (T-LDP) adjacency, wherein the information indicative of the logical communication link comprises information indicative of the T-LDP adjacency and properties of the T-LDP adjacency, and wherein the information indicative of the identified destination comprises an Attachment Circuit (AC) identifier and properties of the AC.

13. A method comprising:
identifying, at a routing apparatus, a logical communication link that is capable of being used to establish a virtual connection between the routing apparatus and other routing apparatus within a virtual connection operational domain of an underlying communication system, the virtual connection operational domain comprising multiple sub-domains;
identifying a destination that is associated with the routing apparatus and is reachable through the virtual connection; and
providing information, which is indicative of the identified logical communication link and of the identified destination, for distribution from a sub-domain of the routing apparatus in the virtual connection operational domain to another sub-domain within the virtual connection operational domain.

14. The method of claim 13, wherein identifying a logical communication link comprises determining another routing apparatus with which the routing apparatus has a signalling adjacency.

15. The method of claim 13, wherein the information indicative of the identified logical communication link comprises information identifying the other routing apparatus.

16. The method of claim 13, wherein the virtual connection comprises a PseudoWire.

17. The method of claim 13, wherein providing comprises providing the information in a message of an Interior Gateway Protocol (IGP).

18. The method of claim 17, wherein the IGP comprises a protocol selected from the group consisting of: Open Shortest Path First (OSPF) protocol and Intermediate System to Intermediate System (IS-IS) protocol.

19. The method of claim 13, further comprising:
the routing apparatus causing the virtual connection to be established using the identified logical communication link.

20. The method of claim 19, wherein causing comprises causing the virtual connection to be established as a segment of a multi-segment virtual connection.

21. The method of claim 13, further comprising:
receiving from another routing apparatus in the virtual connection operational domain information indicative of a logical communication link is capable of being used to establish a virtual connection with the other routing apparatus and of a destination that is associated with the other routing apparatus and is reachable through the virtual connection with the other routing apparatus.

22. A computer-readable medium storing instructions which when executed perform the method of claim 13.

23. A communication traffic routing apparatus comprising:
a routing module operable to cause virtual connections with other routing apparatus within a virtual connection operational domain of an underlying communication system to be established using logical communication links, the virtual connection operational domain comprising multiple sub-domains; and
a route determination module operatively coupled to the routing module and operable to determine whether any of the logical communication links can be used to establish a virtual connection toward a destination in a different sub-domain of the virtual connection operational domain than the routing apparatus, and to select a logical communication link to be used to establish a virtual connection toward the destination where it is determined by the route determination module that a logical communication link can be used to establish a virtual connection toward the destination.

24. The routing apparatus of claim 23, wherein the virtual connection toward the destination comprises a segment of a multi-segment virtual connection.

25. A method comprising:
identifying at a routing apparatus logical communication links that are capable of being used to establish virtual connections with other routing apparatus in a virtual connection operational domain of an underlying communication system, the virtual connection operational domain comprising multiple sub-domains;
determining whether any of the identified logical communication links can be used to establish a virtual connection toward a destination in a different sub-domain of the virtual connection operational domain than the routing apparatus; and
selecting an identified logical communication link to be used to establish a virtual connection toward the destination where it is determined that a logical communication link can be used to establish a virtual connection toward the destination.

26. A computer-readable medium storing a data structure, the data structure comprising:
logical communication link information indicative of a logical communication link that is capable of being used to establish a virtual connection between the routing apparatus and other routing apparatus within a virtual connection operational domain of an underlying communication system, the virtual connection operational domain comprising multiple sub-domains;
destination information indicative of a destination that is associated with the routing apparatus and is reachable through the virtual connection; and
distribution information for causing the logical communication link information and the destination information to be distributed from a sub-domain of the routing apparatus in the virtual connection operational domain to another sub-domain within the virtual connection operational domain,
the logical communication link information and the destination information enabling dynamic routing of the virtual connection toward the destination by routing apparatus in the other sub-domain.

27. The medium of claim 26, wherein the logical communication link information comprises respective Type/Length/Value (TLV) triplets comprising, for each of a plurality of logical communication links that are capable of being used to establish virtual connections between the routing apparatus and other routing apparatus within the virtual connection operational domain, an address of the routing apparatus and an address of a remote routing apparatus with which a virtual connection can be established using the logical communication link.

28. The medium of claim 26, wherein the destination information comprises respective Type/Length/Value (TLV) triplets comprising an address of each destination that is associated with the routing apparatus and is reachable through the virtual connection.
